(19) United States
(12) Patent Application Publication
(10) Pub. No.: US 2009/0309256 A1
(43) Pub. Date: Dec. 17, 2009

(54) Method for stabilizing the spinning solution for production of cellulose composite molded bodies

(76) Inventors: Axel Kolbe, Neundorf (DE); Hardy Markwitz, Rudolstadt (DE); Frank Wendler, Jena (DE); Michael Mooz, Volkmannsdorf (DE)

Correspondence Address: PROPAT, L.L.C., 425-C SOUTH SHARON AMITY ROAD, CHARLOTTE, NC, 28211-2841, US

(21) Appl. No.: 12/373,971

(22) PCT Filed: Jul. 16, 2007
(86) PCT No.: PCT/DE2007/001270

§ 371 Date: Jan. 15, 2009

(30) Foreign Application Priority Data
Jul. 18, 2006 (DE) 10 2006 033 591.0

(51) Int. Cl. B29C 47/06

(52) U.S. Cl. 264/171.1

(57) ABSTRACT

The invention stabilizes spinning solutions used to produce cellulose composite molded bodies incorporating functional materials by the dry-wet extrusion method. The invention incorporates active materials detrimentally affecting the spinning process and materials which are unstable in the cellulose spinning solution, using separate active material and cellulose streams. The active material stream is produced, stabilized and stored separately and mixed with the cellulose stream directly before the forming apparatus, for example, a spinning bar. The active material stream includes amine oxide, functional materials, additives and water. The cellulose stream includes cellulose in amine oxide. The inventive method avoids heat build-up in the moulding or spinning solution, produces cellulose molded bodies with an adequately high degree of polymerisation and excellent functional properties and restricts the decomposition of the amine oxide. The interactions between cellulose and additive are restricted and storage life for the additive suspension improved.

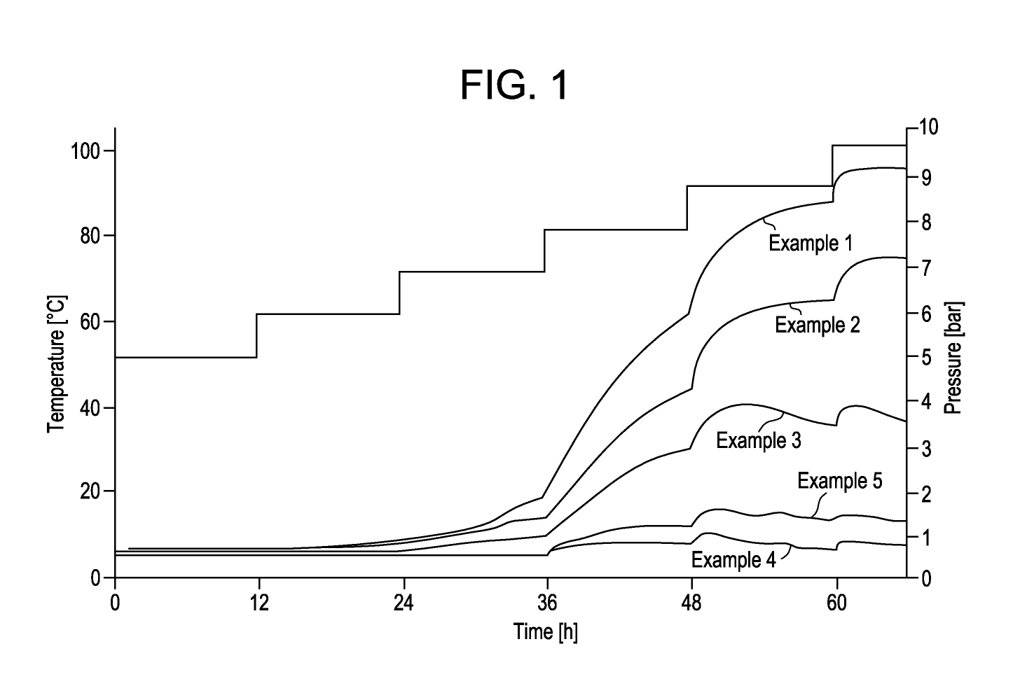

This invention relates to a process for stabilizing the spinning solution for producing shaped cellulosic composite articles having improved properties by the lyocell process, and also to the shaped articles obtained by the process themselves.

Tertiary amine oxides useful as solvents for cellulose are known from U.S. Pat. No. 2,179,181. These amine oxides are thermally not very stable. For instance, N-methylmorpholine N-oxide decomposes into N-methylmorpholine, morpholine, N-formylmorpholine, formaldehyde and CO₂. Stability can be further reduced by heavy metal ions, such as iron or copper (Ferris et al., J. Org. Chem., 33, page 3493 (1968), Taeger et al., Formeln, Faserstoffe, Fertigware, 4, pages 14-22 (1985). Yet metal ions cannot be ruled out owing to the raw materials used and the plant construction.

Producing and shaping amine oxide cellulose solutions at temperatures of 90-130° C. is not without risk owing to predetermined general conditions in that uncontrollable exothermic reactions can take place, determined by admixed materials and reaction products and ambient conditions. Operations which take place in a sufficiently large volume under adiabatic conditions and can lead to a heat buildup are particularly critical. A heat buildup may lead locally to complete degradation of amine oxide, partial degradation of cellulose and partly gaseous reaction products. The result can be an uncontrollable increase in pressure, which can damage the plant.

Stability is also affected on admixture of additives intended to modify the properties of the shaped articles. A weakly acidic ion exchanger was added to the spinning solution in the production of an ion exchange fiber (DE-A 103 15 749). The thermal stability of this solution was distinctly lower than that of an unmodified solution. A similar observation was made in the production of a fiber modified with activated carbon (DE-A 100 53 359).

In addition to the process-engineering risks, an increased thermal instability on the part of the amine oxides also involves economic disadvantages if the solvent is to be recycled. Degradation of the cellulose is likely, which has an adverse effect on the properties of the shaped articles, as well as degradation of the amine oxide.

DD-A 158 656, 218 104 and 0 229 708, DE-A 30 34 685, EP-A 0 111 518 and 0 670 917 and also WO 95/23827 each propose the addition of additives for stabilizing spinning solutions. These stabilization approaches relate exclusively to spinning solutions which do not contain any additional additives for modifying the shaped articles.

DE-A 103 31 342 describes a stabilization concept for spinning solutions which, as well as amine oxide and cellulose, contain functional additives for the shaped articles to be formed.

A metered addition of suitably pretreated additives (pigments) into a shapeable spinning solution of cellulosic derivatives (ethers, esters) with subsequent homogenization and shaping is described in GB-A 374 356.

DE-A 101 40 772 discloses a process for removing heavy metals by using a shaped cellulosic article obtained by the lyocell process. The amine oxide-cellulose solution used for producing the shaped articles contains admixtures which adsorb heavy metals. These are in particular materials from marine plants or marine animals, for example from shells of shrimps, mussels, lobsters or prawns. When this material is particularly sensitive, it can be fed via an injection site directly upstream of the spinneret die or the extrusion mold.

Prior art solution approaches are not sufficient for critical additives, such as the activated carbon from natural products, carbon blacks and ferrites, to be able to shape the spinning solution under controllable conditions safely and economically.

It is an object of the present invention to provide a process whereby not only active materials which have an adverse effect on the spinning operation but also materials which are unstable in the spinning solution can be incorporated in shaped cellulosic articles. The risk of a heat buildup occurring in the shaping or spinning solution shall be minimized therein. At the same time, it shall be possible to spin shaped cellulose articles with a sufficiently high degree of polymerization that have excellent functional properties. Finally, degradation of the amine oxide shall be kept minimal.

We have found that this object is achieved by a process for stabilizing the spinning solution for producing shaped cellulosic-functional particle composite articles having improved properties by the lyocell process, characterized in that active particles which adversely affect or destabilize the process are suspended in amine oxide in a separate stock reservoir vessel at temperatures of less than 80° C., this suspension is stabilized, stored, merged with the cellulose spinning solution and subsequently shaped to form shaped articles.

The amine oxide used is preferably N-methylmorpholine N-oxide (NMMO), which may have a water content.

Preferably, the suspension of active particles in the amine oxide from the stock reservoir vessel is fed via a heatable pipe line and a device for continuous conveyance of the active suspension into continuous turbulent mixing with further viscous streams, in particular cellulose solutions in an amine oxide. The suspension then passes through the shaping module.

In a preferred embodiment, the suspension of active particles is prepared with N-methylmorpholine N-oxide having a water content of not more than 25%.

The process of the present invention is particularly useful for activated carbon of natural origin (preferably coconut shell carbon), carbon blacks, ion exchanger particles and carbon nanotubes. Preference is given to using particles, of the recited materials, having a median particle size of below 15 μm (d99), specifically activated carbon or ion exchanger particles. The functional properties of the shaped articles obtained by following this process are particularly well developed. Compared with the traditional process, where activated carbon is added in the course of the production of the spinning solution, it is found that the addition of activated carbon particles results in double the sorption performance of the shaped articles produced. When 48% of Printex L conductive carbon black was added to the cellulose spinning solution the volume resistivity of the heat-conditioned shaped articles decreased to 1.62 ohm cm in the case of separate streams of material and mixing via dynamic mixer, while the volume resistivity was still 11.35 ohm cm in the case of the same amount of Printex L conductivity carbon black in heat-conditioned shaped articles obtained by following the classic process.

The spinnable shaping dope comprising incorporated functional materials is formed according to the present invention from two different streams which are separately produced, stabilized and stored and only merged immediately upstream of the shaping module, for example a spinning manifold, i.e., the streams are only combined and homogenized immediately upstream of the site of shaping.

The first stream consists of a solution of cellulose in an optionally water-containing amine oxide, preferably N-methylmorpholine N-oxide. The second stream consists of a mixture of amine oxide, preferably N-methylmorpholine N-oxide, particulate functional materials, liquid and solid additives and also water.

The continuously conveyed active suspension with the additive and the further viscous streams, in particular cellulose solutions in an amine oxide, are fed into continuous turbulent mixing, preferably in a dynamic mixer. A dynamic mixer is used to process materials having very short pot lives, widely disparate viscosities and extreme mixing ratios. In addition, process flexibility increases (changeover to other product varieties).

It emerged that, surprisingly, a mixture of N-methyl-morpholine N-oxide and activated carbon, for example, can be stored in a stable and meterable suspension for a sufficiently long period. This process makes it possible to technologically process even chemically reactive additives or additives which have a catalytic effect on the amine oxide or the amine oxide-cellulose system.

The separate production, stabilization, intermediate storage and also uniform and continuous conveying of a stream of functional material and of the cellulose spinning solution and the homogeneous mixing of the two streams only shortly ahead of shaping have the purpose of minimizing the risk of a heat buildup of the shaping or spinning solution occurring; of obtaining shaped cellulose articles having a sufficiently high degree of polymerization and excellent functional properties; and also of keeping the degradation of the amine oxide minimal. At the same time, interactions between cellulose and additive have to be minimized and stock reservoir keeping of the additive suspension ensured.

Active functional additives, for example activated carbon or carbon black in aqueous amine oxide, preferably N-methylmorpholine N-oxide or its monohydrate, are suspended and stabilized separately from the spinning solution and only merged with the cellulose spinning solution shortly ahead of the shaping mold. This suspension can be produced and stored at distinctly lower temperatures compared with the solution of cellulose in amine oxide. It emerged that, surprisingly, stabilization over many hours at temperatures of less than 65° C. is possible in the system of amine oxide/water/functional additive, stabilization conditions which are not sufficient for the system of amine oxide/cellulose/functional additive/water. This gives rise to the idea of a suspension of functional additive in amine oxide being initially prepared and stabilized in a stock reservoir vessel. The suspension of active particles can be stabilized by admixing it with hydroxylamine and propyl gallate to increase the storability by reducing the degradation of N-methylmorpholine N-oxide. Another way of stabilizing the suspension is to add hydroxides, such as sodium hydroxide, and metal ion-binding stabilizers (chelate-forming iminodiacetic acid or its alkali metal salts attached to a styrene-divinylbenzene copolymer) and aldehyde-binding stabilizers (benzylamine attached to a styrene-divinylbenzene copolymer). From this vessel, the cool suspension is conveyed via a heated short pipe line and in the process the temperature is equalized to the processing temperature of the cellulose solution. This can take place within 0-10 min. It is only just ahead of shaping that it is necessary to combine the streams of cellulose solution and functional additive suspension with each other. This is preferably done using a dynamic mixer which combines the functional additive suspension from the side stream and the cellulose solution to form the actual spinning and shaping dope. This shaping dope is immediately spun.

The present invention finally also provides the shaped cellulosic composite articles obtained by following the process of the present invention themselves.

The invention is more particularly described with reference to the examples recited hereinbelow. The test methods used to evaluate the thermal stability of cellulose solutions are briefly outlined in what follows. The assessment criteria used were the onset temperature and the dynamic analysis of pressure, temperature and time.

### Dynamic Viscosity

Dynamic viscosity (zero shear viscosity) was measured with a Rheostress 100 rheometer with a TC 500 heat-conditioning device from Haake (reference temperature 85° C.). The measurements were carried out immediately after production of the shaping or spinning solution.

### Reaction Calorimeter (Miniautoclave)

The tests for accelerated exothermic decomposition reactions were carried out with a Radex safety calorimeter from System Technik Deutschland GmbH. 2 g of the shaping or spinning solution were weighed into a sealed steel vessel (proof pressure 100 bar, bursting disk). Temperature course and pressure course were monitored via two modes of measurement.

### 1. Dynamic

The sample was heated from room temperature to 300° C. at a heating rate of 0.75 K/min. To evaluate the stability of the samples, the lowest temperature (onset temperature; Tₒₙ) at which the substance under test showed a significant pressure increase dp/dt was determined.

### 2. Isoperibolic

In an isoperibolic staged experiment, the temperature was raised at 2 K/min to a defined ambient temperature and then maintained 12 hours at that temperature.

Subsequently, the temperature was raised by 10 K and again maintained for 12 hours. Stages of 50, 60, 70, 80, 90 and 100° C. were used. The course of the pressure was recorded as well as the temperature.

The onset temperature indicates the onset of the decomposition of the spinning solution. In the cases mentioned, the onset temperature decreased by about 20° C. to about 130° C. When the influence of temperature and time was investigated, a distinctly shortened time span was measured, compared with unmodified spinning solutions, to record a pressure increase at 130° C.

### EXAMPLE 1

Spinning solution: The reaction vessels of the mini pilot plant were charged with 1510.9 g of 50.5% NMMO (N-methylmorpholine N-oxide) as initial charge to which 128.8 g of spruce pulp having a residual moisture content of 6.9% by mass and a degree of polymerization (DP) of about 495 were added. Stabilization was with 0.06% by mass of propyl gallate and 0.04% by mass of sodium hydroxide, based on the spinning solution. The reactor was sealed and the slurry was stirred at room temperature for 15 minutes and subsequently a vacuum of 30 mbar was applied. The temperature in the kneader was raised to 90° C. in stages. The dissolving was complete after about 240 minutes.

Suspension: The stock reservoir vessel for side stream metering was charged with 1453 g of 50.5% NMMO (N-methylmorpholine N-oxide) as initial charge to which 752 g of reactive activated carbon having a residual moisture content of 2.2% by mass, a surface area (BET) of 1222 m²/g and a particle size of about 8 μm were added. By way of stabilization, 21.5 g each of a metal ion-binding stabilizer (chelate-forming iminodiacetic acid or its alkali metal salts attached to a styrene-divinylbenzene copolymer) and an aldehyde-binding stabilizer (benzylamine attached to a styrene-divinyl-benzene copolymer) were used. The vessel was sealed and the suspension was stirred at room temperature for 15 minutes and subsequently a vacuum of 30 mbar was applied. The temperature in the kneader was raised to 60° C. in stages. The storage test was complete after about 240 minutes.

The stability of the individual spinning solutions and suspensions was tested by using the above-described tests in the reaction calorimeter, pH measurement and formaldehyde measurement.

### EXAMPLE 2

Example 1 was repeated for suspension 2 using twice the amount of the polymer-attached stabilizers (43 g each).

### EXAMPLE 3

Example 1 was repeated for suspension 3 by raising the temperature in the kneader in stages to just 40° C.

### EXAMPLE 4

Example 1 was repeated for suspension 4 by adding about 25 ml of 5% strength NaOH in addition to the polymer-attached stabilizers.

### EXAMPLE 5

Suspension 5 was prepared similarly to Examples 1 and 4. The storage test was terminated after 24 h.

Table 1 shows the onset temperature (Tₒₙ), pH values and formaldehyde concentrations in the distillate of the suspension prepared

TABLE 1

| | Examples | | | | |
|---|---|---|---|---|---|
| | 1 | 2 | 3 | 4 | 5 |
| Tₒₙ | 100° C. | 101° C. | 105° C. | 108° C. | 106° C. |
| pH | 9.50 | 9.58 | 9.52 | 11.69 | 11.60 |
| HCHO | 360 mg/l | 24 mg/l | 13 mg/l | 25 mg/l | 18 mg/l |

Table 2 below shows maximum pressure increases (dp/dt) and maximum pressures (pₘₐₓ) of the isoperbolic measurements at 50, 60, 70, 80, 90 and 100° C., 12 h each, for the suspensions of Examples 1-5.

The graph shows the isoperibolic pressure measurements at 50, 60, 70, 80, 90 and 100° C., 12 h each, for the suspensions of Examples 1-5.

TABLE 2

| | Example 1 | | Example 2 | | Example 3 | | Example 4 | | Example 5 | |
|---|---|---|---|---|---|---|---|---|---|---|
| Temperature | dp/dt | pₘₐₓ | dp/dt | pₘₐₓ | dp/dt | pₘₐₓ | dp/dt | pₘₐₓ | dp/dt | pₘₐₓ |
| 50° C. | 0 | 0.61 | 0 | 0.67 | 0 | 0.61 | 0 | 0.65 | 0.0001 | 0.55 |
| 60° C. | 0.0061 | 0.79 | 0.0061 | 0.79 | 0.0046 | 0.61 | 0.0060 | 0.55 | 0 | 0.55 |
| 70° C. | 0.0073 | 1.89 | 0.0063 | 1.40 | 0.0051 | 1.04 | 0.0061 | 0.61 | 0.0061 | 0.55 |
| 80° C. | 0.0149 | 5.92 | 0.0115 | 4.33 | 0.0061 | 2.99 | 0.0064 | 0.79 | 0.0069 | 1.22 |
| 90° C. | 0.0214 | 8.42 | 0.0184 | 6.25 | 0.0089 | 3.91 | 0.0082 | 1.04 | 0.0093 | 1.59 |
| 100° C. | 0.0211 | 9.22 | 0.0170 | 7.21 | 0.0161 | 3.91 | 0.0085 | 0.85 | 0.0071 | 1.42 |

dp/dt in [bar/min] and p in [bar]

As is discernible from Table 1, onset temperatures of about 100° C. are obtained. The onset temperature indicates the first thermal activity of a substance. Given a decomposition temperature of 172° C. for pure NMMO, these low onset temperatures indicate a very sizeable degradation effect. The surface activity of the activated carbon has a catalytic effect on decomposition of the NMMO (Wendler et al., macromol. Mat. Eng., 2005, 290, 826-832). By using the stabilization of the present invention (Examples 4 and 5) the onset temperature can be shifted slightly to higher values. The very high value of 360 mg/l of formaldehyde in the distillate, by contrast, can be very greatly reduced. The release of formaldehyde is viewed in connection with the decomposition of the NMMO degradation (Rosenaue et al., Prog. Polym. Sci., 2001, 26, 1763-1837).

Isoperibolic staged experiments are more informative for evaluating long-term stability, since production plants can generally give rise to technologically based shutdown periods due to intermediate storage and transportation. It is therefore necessary to test the thermal stability of the suspensions at constant temperatures over prolonged periods.

Table 2 reports the pressure increases and the attained maximum pressures for temperature intervals of 12 h each. The suspensions according to Examples 1 and 2 show after just 24 h, when the temperature is raised from 60 to 70° C., pronounced pressure increases which intensify from 80° C. and reach their maximum at 90° C. Similarly, the suspension of Example 3, which was heated to 40° C. only, has a similar pressure course with a maximum increase at 90° C., but the pressure course curve is below that of the first examples. By contrast, the pressure increase of the suspension of Example 4 is only observable at 90° C. and then immediately weakens again. This smaller pressure increase is a sign of lower decomposition on the part of the NMMO, corresponding to improved thermal stability for the suspension. When the suspension is stored for 24 h (Example 5), somewhat higher pressure increases compared with Example 4 are observed, but at maximum pressures below 2 bar. The graph shows the course of the measured curves.

The introduction of reactive activated carbon according to Example 4 led to fibers having advantageous adsorption properties with very good uptake capacities for organic solvents.

1. A process for stabilizing the spinning solution for producing shaped cellulosic composite articles by the lyocell process
comprising suspending active particles which adversely affect or destabilize the lyocell process in amine oxide in a separate stock reservoir vessel at temperatures of less than 80° C.,
stabilizing the active particle suspension,
storing the stabilized active particle suspension,
merging the stored active particle suspension with cellulose solution and subsequently
shaping the merged suspension and solution to form shaped articles.

2. The process according to claim 1, wherein the amine oxide is N-methylmorpholine N-oxide or its monohydrate.

3. The process according to claim 1, said process further comprising
feeding the stored active particle suspension from the stock reservoir vessel
via (i) a heated pipe line and (i) a device for continuous conveyance of the active particle suspension
into a continuous turbulent mixer in which the active particle suspension is merged with the cellulose solution in an amine oxide and
passing the combined suspension and solution through the shaping module.

4. The process according to claim 1, wherein said process further comprises combining and homogenizing the active particle suspension and cellulose spinning solution and/or the farther viscous cellulose solutions immediately prior to the shaping step.

5. The process according to claim 3, wherein the continuously conveyed active particle suspension and cellulose solution in an amine oxide are merged in a dynamic mixer providing continuous turbulent mixing.

6. The process according to claim 1, wherein the active particles are suspended in N-methylmorpholine N-oxide having a water content of not more than 25%.

7. The process according to claim 1, wherein the active particles are activated carbon, carbon blacks, carbon nanotubes or ion exchangers.

8. The process according to claim 7, wherein the active particles have a median particle size of below 15 μm (d99).

9. The process according to claim 7, wherein the activated carbon is of natural origin.

10. The process according to claim 1, wherein the storage temperature for the stabilized active particle suspension is 50 to 65° C.

11. The process according to claim 1, wherein the stabilization step comprises admixing the active particle suspension with hydroxides, metal ion-binding stabilizers and/or aldehyde-binding stabilizers.

12. The process according to claim 11, wherein the hydroxide comprises sodium hydroxide, the metal ion-binding stabilizer comprises chelate-forming iminodiacetic acid or alkali metal salts thereof attached to a styrene-divinylbenzene copolymer, and the aldehyde-binding stabilizer comprises benzylamine attached to a styrene-divinylbenzene copolymer.

13. The process according to claim 1, wherein the stabilization step comprises admixing the active particle suspension with hydroxylamine and propyl gallate.

14. A shaped article obtained by following the process according to claim 1.

15. The process according to claim 9, wherein the activated carbon is coconut shell carbon.
